(19) United States
(12) Patent Application Publication
(10) Pub. No.: US 2022/0379256 A1
(43) Pub. Date: Dec. 1, 2022

(54) FILTER CLEANING

(71) Applicant: Hewlett-Packard Development Company, L.P., Spring, TX (US)

(72) Inventors: Rhys Mansell, Sant Cugat del Valles (ES); Mohammad Jowkar, Sant Cugat del Valles (ES); Ahmed Elibiary, Sant Cugat del Valles (ES)

(21) Appl. No.: 17/762,678

(22) PCT Filed: Jan. 29, 2020
(86) PCT No.: PCT/US2020/015693

§ 371 Date: Mar. 22, 2022

(51) Int. Cl. B01D 46/71; B29C 64/35

(52) U.S. Cl. CPC B01D 46/71; B29C 64/35; B33Y 30/00

(57) ABSTRACT

According to one example, there is provided a method of cleaning a filter in a filter housing. The filter has a dirty side at which a dirty airflow is received, and a clean side through which a cleaned airflow flows. The method comprises generating a cleaning airflow at the dirty side of the filter, the cleaning airflow having a predetermined volume and pressure, and generating an extraction airflow to extract from the filter housing the same volume and pressure of air from the filter housing as that generated in the filter housing by the cleaning airflow.

### BACKGROUND

There exist a multitude of kinds of three-dimensional (3D) printing techniques that allow the generation of 3D objects through selective solidification of a build material based on a 3D object model. Powder-based 3D printing systems generate 3D objects by successively forming layers of a 3D printing material, such as a powder, in a build chamber and selectively solidifying portions of each layer to form the object layer-by-layer.

### BRIEF DESCRIPTION

Examples will now be described, by way of non-limiting example only, with reference to the accompanying drawings, in which:

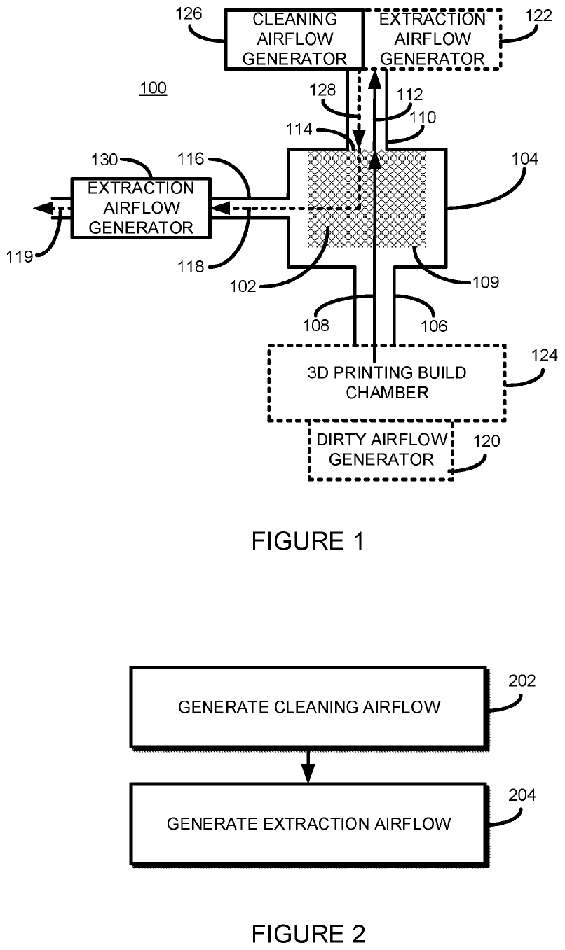

FIG. 1 is a block diagram showing a filter cleaning system according to an example;

FIG. 2 is a flow diagram outlining a method of cleaning a filter according to an example; and

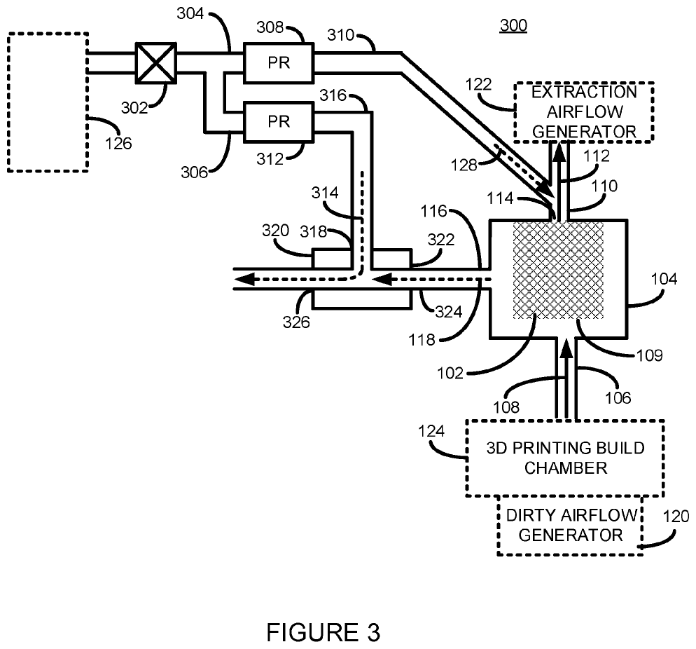

FIG. 3 is a block diagram showing a filter cleaning system according to one example.

### DETAILED DESCRIPTION

The formation of layers of powder in a build chamber may be achieved, for example, by providing a volume of powder at one side of the build chamber, and then spreading the provided volume of powder over a build platform provided in the build chamber, or over a previously formed layer, to form the layer. Spreading may be performed, for example, by a roller or a wiper. In other examples, powder may be deposited directly on a build platform, for from an overhead hopper. Powder may be any suitable build material powder, such as plastic powder, ceramic powder, and metal powder. Common 3D printing powders may comprise particles having a size between about 1 to 50 microns.

Selective solidification of build material may be achieved in a number of different manners. For example, a directional heat source, such as a laser, may be used to heat and melt (or sinter) portions of each layer based on data representing a cross-section of a layer of an object to be generated. In other systems, an energy absorbing fusing agent may be selectively printed onto a layer of powder to cause, upon application of a generally unfocussed energy source, portions of the powder on which fusing agent is applied to heat up and melt. Upon cooling, the melted portions form a layer of the object. In other examples, a thermally curable or an ultra-violet light curable binder agent may be applied to portions of each layer to bind powder particles together to form a layer of an object.

During layer formation and layer solidification powder particles may become airborne. For example, powder particles may be physically disturbed by a spreading roller, and may be affected by turbulence generated from printheads, carriages, or the like, being moved over the build chamber at speed. To prevent airborne powder from settling at undesirable locations within a 3D printer, powder-based 3D printers generally include filter systems to remove airborne powder from air within the 3D printer.

Filters, however, tend to clog up with particulates over time and have to be cleaned regularly to maintain suitable airflow levels therethrough. Manual cleaning or changing of filters may be suitable for low-volume production 3D printers, but is not suitable for high-volume 3D printing production environments where reducing manual intervention and printer downtime is a goal. Automated filter cleaning processes do exist, for example, using air blow-back to dislodge particulates from a dirty side of a filter, however such systems generate a back flow of air into the dirty air source. However, powder-based 3D printing systems that use heat to solidify powder or cure binder agents may be particularly sensitive to changes in parameters such as temperature, airflow rate, and pressure, and even minor changes to these parameters can cause quality issues in generated 3D objects. Consequently, air blow-back filter cleaning systems are not suitable for use during 3D printing operations and hence may only be used when a 3D printer is not printing objects.

The examples described herein, however, enable filter cleaning within a 3D printer to take place during 3D printing operations, without affecting the pressure or airflow within a 3D printing chamber.

Referring now to FIG. 1, there is shown a filter cleaning system 100 for use in a system such as a 3D printer according to an example. FIG. 2 is a flow diagram outlining a method of cleaning a filter according to an example. The system 100 comprises a removable filter 102, such as a foam or paper filter located in a filter housing 104. The filter housing 104 comprises a dirty air input 106 to provide a dirty airflow 108 to a dirty side 109 of the filter 102. The dirty airflow 108 may come, for example, from a 3D printing build chamber 124. The filter housing 104 also comprises a cleaned air output 110 through which a cleaned airflow 112, substantially devoid of particulates, may flow from a clean side 114 of the filter 102. The filter housing 104 also comprises an extraction output 116, through which an extraction airflow 118 may flow during a filter cleaning operation, as will be described further below.

The filter 102 is substantially sealed within the filter housing 104, with the dirty side 109 of the filter being isolated from the clean side 114 of the filter such that no air may flow out of the cleaned air output 110 without having been filtered by the filter 102.

In one example, the dirty airflow 108 and the cleaned airflow 112 are generated by a dirty airflow generator 120 that provides a positive pressure to the dirty side of the filter 109. In another example, the dirty airflow 108 and cleaned airflow 112 are generated by cleaned air extraction airflow generator 122 that provides a negative pressure to the clean side 114 of the filter 102. In another example, the dirty airflow 108 and the cleaned airflow 112 are generated by a combination of the dirty airflow generator 120 and the cleaned air extraction airflow generator 122.

In operation, the filter 102 will become clogged with particulates from the dirty airflow 108 and will have to be periodically cleaned to prevent the filter 102 from restricting the dirty airflow 108 and causing a change in pressure and/or airflow in the 3D printing build chamber 124.

To clean the filter 102, a cleaning airflow generator 126 is used to generate (block 202) a temporary cleaning airflow 128 which is directed to the clean side 114 of the filter 102. In one example, the cleaning airflow generator 126 is configured to generate the cleaning airflow 128 having a positive pressure and a predetermined volume to generate a predetermined pressure within the filter housing 104. In one example, the cleaning airflow 128 is generated by rapidly discharging a predetermined volume of air stored at a predetermined pressure in a pressurized reservoir. In one example, the cleaning airflow 128 is generated by rapidly discharging from the pressurized reservoir between about 0.001 m³ and 0.125 m³ of air at a pressure of around 5 bars. In other examples, the cleaning airflow 128 may be generated by discharging a different volume of air at a higher or a lower pressure, as appropriate. In one example, discharging of the cleaning airflow 128 may be achieved by temporarily opening a valve of a pressurized air reservoir, for example for a suitable duration such as 0.1 seconds, 0.5 seconds, 1 second, 2 seconds, or 5 seconds. The cleaning airflow 128 acts to dislodge particulates trapped in the dirty side 109 of the filter 102 and causes at least some of those particulates to dislodge from the filter 102, thereby at least partially cleaning the filter 102. In one example, the cleaning airflow generator 126 is configured to generate a short pulse of compressed air have a duration of between about 0.5 and 2 seconds, although in other examples other suitable durations of cleaning airflow may be generated.

To prevent any change in pressure within the 3D printing chamber 124 during a filter cleaning operation, an extraction airflow generator 130 is used to generate (block 204, FIG. 2) an extraction, airflow 118. The extraction airflow generator 130 is configured such that the generated extraction airflow 118 has the same volume as the cleaning airflow 128 and has a negative pressure having the same magnitude of pressure within the filter housing 104 as the cleaning airflow 128. The cleaning airflow 128 is generated at the same time as the cleaning airflow 128 such that the extraction airflow 118 simultaneously extracts the cleaning airflow 128 from the filter housing 104, such that there is no net pressure increase (or only a net pressure change within acceptable limits) within the filter house 104. In other words, the extraction airflow generator 130 extracts the volume and pressure of air from the filter housing 104 as that generated in the filter housing 104 by the cleaning airflow generator 126. This thus also prevents a change in pressure (or at least an unacceptable change in pressure) within the 3D printing build chamber 124. In one example, extraction airflow generator 130 is configured to generate a pulse of extraction airflow from the filter housing 104, the extraction airflow having a duration and pressure substantially equal to that of the cleaning airflow 128. The extraction airflow 118 is exhausted from the extraction airflow generator 130 as an exhaust airflow 119.

A cleaning airflow 128 and corresponding extraction airflow 130 may thus be generated periodically or whenever it is determined that the filter 102 is to be cleaned. Since the cleaning airflow 128 does not cause any substantial pressure change with 3D printing build chamber 124, the filter cleaning operation may be performed whilst the 3D printing build chamber is being used to generate 3D printed objects, without disturbing the pressure or airflow within therein. This allows, for example, cleaning of the filter 102 without having to wait for a 3D printing process to have completed. This may, for example, enable a 3D printer to perform for longer with shorter periods of downtime, which is particularly useful in industrial environments where high productivity is a goal.

In one example, the apparatus 100 is configured such that at least some of the powder dislodged from the dirty side 109 of the filter 102 is removed by the extraction airflow 118. The extraction airflow 118 may, for example, by passed through a water bath filter to remove any powder therefrom, prior to the extraction airflow 118 being released to the environment or a suitable air conditioning system. In another example, the apparatus 100 is configured such that at least some of the powder dislodged from the dirty side 109 of the filter 102 may fall under gravity into a powder store (not shown) for later removal. In another example, the apparatus 100 is configured such that at least some of the dislodged powder is removed by the extraction airflow 118 and at least some of the dislodged powder is stored in a powder store within the filter housing 104.

The apparatus 100 may comprise a synchronization system (not shown) to synchronize the generation of the cleaning airflow 128 and the extraction airflow 118 at substantially the same (or within a predetermined time period, such as within 1 second, within 0.5 seconds, within 0.1 seconds, within 0.01 seconds). In one example, the synchronization system comprises a controller or electrical or pneumatic coupling to cause the extraction airflow generator 130 to generate the extraction airflow 118 at the same time as the cleaning airflow generator 126 generates the cleaning airflow 128.

Referring now to FIG. 3 there is shown a filter cleaning system 300 according to one example. Elements similar or the same as those illustrated in FIG. 1 are labelled, for convenience, with the same reference numbers. The system 300 comprises a valve 302 connected to a cleaning airflow generator 126. The cleaning airflow generator may, for example, be a bottle of compressed air, an air compressor, or the like. The valve 302 may be an electromechanical valve to enable the valve 302 to be opened and closed in response to an electrical or other suitable control signal. An output conduit 304 connected to the output of the valve splits into a first conduit 304 and a second conduit 306 such that when the valve 302 is opened a portion of the airflow from the cleaning airflow generator 126 flows through each of the first and second conduits.

The first conduit 304 is connected to a first pressure regulator 308 to generate a reduced pressure cleaning airflow 128 in a cleaning airflow conduit 310. The cleaning airflow conduit 310 fluidically communicates with a conduit connected to the cleaned air output 110 of filter housing 104, through which the cleaned airflow 112 flows. The angle at which the cleaning airflow conduit 310 intersects the cleaned air output conduit 110 is such that when the cleaning airflow 128 is generated it is directed to the clean side 114 of the filter 102. The cleaning airflow 128 is to dislodge particulates from the filter 102 as described above.

The second conduit 306 is connected to a second pressure regulator 312 to generate a vacuum generation airflow 314 in a conduit 316. The conduit 316 is connected to a vacuum generation port 318 of a venturi pump 320. The venturi pump 320 generates a vacuum, or negative pressure, airflow 118 at an extraction or vacuum port 322 in response to the vacuum generation airflow 314 being applied to the vacuum generation port 318. The extraction port 322 is connected to the filter housing 104 via a conduit 324 such that the generated vacuum, or extraction, airflow 118 is applied to the interior of the filter housing 104. The air extracted from the filter housing 104 and the vacuum generation airflow 314 are exhausted from the venturi pump 320 via an exhaust port 326.

The pressure regulators 308 and 312 are configured such that the extraction airflow 118 generated by the venturi pump 320 and the cleaning airflow 128 are equal in pressure and magnitude, such that generation of the cleaning airflow 128 acts to clean the filter 102 without changing the overall pressure in the filter housing 104, and without changing the pressure in the 3D printing build chamber 124, as described above. This configuration can, for example, be determined in advance, for example based on characteristics of the venturi pump 320, or can be determined through appropriate testing.

Although the term ‘air’ has been generally used throughout the description it will be appreciated that in other examples other gases may be used instead of air. For example, in 3D printing systems that operate in an inert environment, nitrogen or other gases may be used in place of air.

Although the term ‘3D printing build chamber’ has been used throughout, it will be appreciated that in other examples any other source of dirty air contaminated with particulates may be provided.

It will be appreciated that example described herein can be realized in the form of hardware, software or a combination of hardware and software.

All the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

1. Apparatus for cleaning a filter, comprising:
a filter housing to house a filter, the filter to remove particulates from a dirty airflow, the filter having a dirty side and clean side;
a cleaning airflow generator to generate a temporary cleaning airflow at the clean side of the filter to dislodge particulates from the dirty side of the filter, the cleaning airflow having a predetermined volume and pressure; and
an extraction airflow generator to simultaneously extract the generated cleaning airflow from the filter housing.

2. The apparatus of claim 1, wherein the extraction airflow generator is to generate an extraction airflow to extract the same volume and pressure of air from the filter housing as that generated in the filter housing by the cleaning airflow generator.

3. The apparatus of claim 1, wherein the dirty airflow comes from a chamber, and wherein the simultaneous generation of the cleaning airflow and the extraction does not cause a change in pressure in the chamber.

4. The apparatus of claim 1, wherein the extraction airflow is to extract particulates dislodged from the dirty side of the filter.

5. The apparatus of claim 1, further comprising a powder store within the filter housing to store particulates dislodged from the dirty side of the filter.

6. The apparatus of claim 1, wherein the extraction airflow generator is a venturi pump having an input port, an extraction port, and an exhaust port to exhaust air input through the input port and air drawn through the extraction port, the printer further comprising:
a conduit to provide, from the cleaning airflow generator, a flow of compressed air through a controllable valve, the conduit splitting after the valve into the first conduit and the second conduit;
a first pressure regulator in the first conduit to provide a first compressed airflow at a first predetermined pressure into the clean side of the filter; and
a second pressure regulator in the second conduit to provide a second compressed airflow at a second predetermined pressured into the venturi pump input port to generate an extraction airflow at the extraction port to simultaneously extract the first compressed airflow from the filter housing.

7. The apparatus of claim 1, wherein the cleaning airflow generator comprises a pressurized reservoir to store pressurized air, and wherein the cleaning airflow is to be generated by discharging a predetermined volume of air stored therein.

8. The apparatus of claim 7, wherein the pressurized reservoir is to store air at a pressure of about 5 bars, and wherein the cleaning airflow is generated by discharging a volume of air in the region of 0.001 m³ to 0.125 m³ from the reservoir.

9. A method of cleaning a filter in a filter housing, the filter having a dirty side at which a dirty airflow is received, and a clean side through which a cleaned airflow flows, the method comprising:
generating a cleaning airflow at the dirty side of the filter, the cleaning airflow having a predetermined volume and pressure; and
generating an extraction airflow to extract from the filter housing the same volume and pressure of air from the filter housing as that generated in the filter housing by the cleaning airflow.

10. The method of claim 9, further comprising:
dislodging particulates from the dirty side of the filter with the cleaning airflow; and
extracting at least a portion of the dislodged particulates from the filter housing in the extraction airflow.

11. The method of claim 9, further comprising storing at least a portion of the dislodged particulates within the filter housing.

12. A three-dimensional printer, comprising:
a filter housing to house a filter, the filter having a dirty side to receive a dirty airflow from a print chamber, and a clean side through which is to flow a cleaned airflow;
a cleaning airflow generator to provide a cleaning airflow having a predetermined volume and a predetermined pressure to the clean side of the filter to dislodge particulates from the dirty side of the filter; and
an extraction airflow generator to extract from the filter housing the same volume and pressure of air from the filter housing as that generated in the filter housing by the cleaning airflow.

13. The printer of claim 12, wherein the extraction airflow is generated with a venturi pump using a portion of the cleaning airflow.

14. The printer of claim 13, wherein the venturi pump has an input port, an extraction port, and an exhaust port to exhaust air input through the input port and air drawn through the extraction port, the printer further comprising:
a conduit to provide, from the cleaning airflow generator, a flow of compressed air through a controllable valve, the conduit splitting after the valve into the first conduit and the second conduit;
a first pressure regulator in the first conduit to provide a first cleaning airflow into the clean side of the filter; and
a second pressure regulator in the second conduit to provide a second compressed airflow into the venturi pump input port to generate an extraction airflow at the extraction port to simultaneously extract the first airflow from the filter housing.

15. The printer of claim 12, configured to clean the filter using the cleaning airflow whilst 3D objects are being generated in the print chamber.
